(19) United States
(12) Patent Application Publication
(10) Pub. No.: US 2008/0162889 A1
(43) Pub. Date: Jul. 3, 2008

(54) METHOD AND APPARATUS FOR IMPLEMENTING EFFICIENT DATA DEPENDENCE TRACKING FOR MULTIPROCESSOR ARCHITECTURES

(75) Inventors: Gheorghe Calin Cascaval, Carmel, NY (US); Luis Henrique Ceze, Urbana, IL (US)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: INTERNATIONAL BUSINESS MACHINES CORPORATION, Armonk, NY (US)

(21) Appl. No.: 11/619,355

(22) Filed: Jan. 3, 2007

(51) Int. Cl. G06F 9/312

(52) U.S. Cl. 712/216; 712/E09.033

(57) ABSTRACT

A system for tracking memory dependencies includes a speculative thread management unit, which uses a bit vector to record and encode addresses of memory access. The speculative thread management unit includes a hashing unit that partitions the addresses into a load hash set and a store hash set, a load hash set unit for storing the load hash set, a store hash set unit for storing the store hash set, and a data dependence checking unit that checks data dependence when a thread completes, by comparing a load hash set of the thread to a store hash set of other threads.

This invention was made with Government support under Contract No.: NBCH30390004 (DARPA) awarded by Defense Advanced Research Projects Agency (DARPA). The Government has certain rights in this invention.

### BACKGROUND OF THE INVENTION

1. Field of the Invention

The present invention generally relates to a method and apparatus for tracking memory dependencies, and more particularly to a method and apparatus for efficient disambiguation for multiprocessor architectures.

2. Description of the Related Art

Thread-level speculation (TLS) was initially proposed to enable the exploitation of parallelism in applications that are hard to parallelize. In environments that support TLS, the compiler parallelizes code aggressively even when it can not prove data independence. The hardware runs the code in parallel while keeping track of data dependencies dynamically. When there is a data dependence violation, the offending thread is restarted and execution proceeds correctly.

Keeping track of memory dependencies among the speculative threads and the main thread requires information about the memory accesses performed by the various threads. Conventionally, memory accesses are usually kept by either having a table that enumerates all addresses accessed by the threads, or by extending the cache tags.

All conventional mechanisms maintain the exact set of memory data dependencies between threads. There are at least two drawbacks with these conventional approaches. First, the amount of data to be kept up-to-date is relatively large, and second, the extra actions required for tracking dependencies have a negative effect on performance. When tables are used, there are limited hardware resources that can be allocated to tables and it is therefore necessary to take additional actions when the tables get full. In the case of using the cache, lines need to be locked, and therefore affect performance. These factors make the conventional schemes hard to scale.

Using hashing functions to track memory addresses has been proposed and used in the past for filtering messages in a cache coherence network. These techniques use a Bloom filter to encode a super-set of the lines present in the local cache. Before an external cache request accesses the local cache structure, the hash is checked, and if the address is present in the hash super-set, then it may be present in the cache and the actual local cache lookup happens.

A data dependence detector using a hashing scheme has been used conventionally. The output of the hashing function proposed is a single entry number that addresses a single bit vector—the actual hash value. The dependence checking is done at every memory instruction, which is expensive. In addition, this conventional scheme has a potentially high false-positive ratio, since the address of all load instructions are added to the hash value, even if the load might not be an exposed data dependence. Therefore, it is desired to allow for dependence checking when the speculative task completes and also to reduce the number of false dependencies.

Similar hashing schemes were also proposed for memory disambiguation in out-of-order processors.

There has been a significant amount of work in memory disambiguation for superscalar processors. Most proposals focus on per-instruction single-thread disambiguation. There exists a need for an efficient technique for task-level (or thread-level) disambiguation for multiprocessor architectures.

Most conventional schemes are tightly integrated with the L1 cache of the processor, which is a very timing sensitive structure, and therefore these schemes tend to be very complex in order to maintain performance.

### SUMMARY OF THE INVENTION

In view of the foregoing and other exemplary problems, drawbacks, and disadvantages of the conventional methods and structures, an exemplary feature of the present invention is to provide an efficient method and structure for task-level (or thread-level) disambiguation for multiprocessor architectures.

In a first aspect of the present invention, a system for tracking memory dependencies integrated with a processor, includes a speculative thread management unit, which uses a bit vector to record and encode addresses of memory access. The speculative thread management unit includes a hashing unit that partitions the addresses into a load hash set and a store hash set; a load hash set unit for storing the load hash set; a store hash set unit for storing the store hash set; and a data dependence checking unit that checks data dependence when a thread completes by comparing a load hash set of the thread to a store hash set of other threads, wherein in a case of speculative execution, the other threads include threads that are either all of a plurality of less speculative threads or a next speculative thread, and wherein in a case of parallel execution the other threads include all threads that are currently running with the thread. The comparing includes performing a bitwise logical AND between pairs of data subsets from the load hash set and the store hash set. The speculative thread management unit updates the load hash set and the store hash set.

The present invention presents a novel mechanism for tracking memory dependencies in processor architectures that support multiple threads which run concurrently an application. These threads may be speculatively generated and spawned, or may be specified by a programmer using a relaxed consistency memory model. Applicants have observed that maintaining a superset of memory data dependencies between threads is enough to guarantee correctness and that the hardware structures necessary to maintain such a superset are much simpler and efficient than the hardware required to maintain a precise set of the memory data dependencies between threads.

The present invention may include a new protocol for data dependence disambiguation, in which the dependence checking is performed on summaries of data dependencies and a dynamically adjustable hashing function that encodes a set of data memory addresses into a single arbitrarily-sized string of bits.

Furthermore, the present invention may include a hardware structure that keeps the addresses of recent stores which removes false dependencies of loads to addresses that have been previously written by the issuing thread, and a counter based hash that allows a more precise control of what address summaries are used in the data dependence detection process. These two features increase the effectiveness of the present method and system.

The present invention provides an efficient technique for task-level (or thread-level) disambiguation for multiprocessor architectures.

Instruction-level disambiguation techniques may also be used for task-level (or thread-level) disambiguation. In this case, dependence violations are detected as soon as the violating instruction is executed. For each memory instruction executed, the memory access history of the tasks needs to be checked, which generally requires a significant amount of complex structures.

Applicants have observed that detecting dependencies only at the end of tasks does not necessarily cause significant performance degradation. For that reason, the present invention provides an efficient technique for task-level memory disambiguation.

Using summary hashes for instruction-level disambiguation has been proposed in the past. In those proposals, however, individual instruction addresses are compared directly with hash summaries. In the present invention, since the benefit is mostly due to comparison at task completion-time, hashes are compared against hashes (store hash-set against load hash-set). This is a fundamental difference from the conventional techniques, since many individual checks are replaced by a single “bulk” comparison by comparing hashes.

The present invention isolates the memory disambiguation logic into a separate unit and thus provides two advantages. First, it keeps the processor cache structures essentially unmodified, which is beneficial for both the design simplicity and performance. Second, it allows for the disambiguation mechanisms to be enabled and disabled as necessary.

### BRIEF DESCRIPTION OF THE DRAWINGS

The foregoing and other exemplary purposes, aspects and advantages will be better understood from the following detailed description of an exemplary embodiment of the invention with reference to the drawings, in which:

FIG. 1 illustrates a speculative thread management unit 100 in accordance with an exemplary embodiment of the present invention;

FIG. 2 illustrates a processor 200 including the speculative thread management unit 100 in accordance with an exemplary embodiment of the present invention;

FIG. 3 illustrates a hash-set implementation in accordance with an exemplary embodiment of the present invention;

FIG. 4 illustrates a logic diagram for checking a dependence among threads in accordance with an exemplary embodiment of the present invention; and

FIG. 5 exemplarily illustrates dependence violation checking among multiple threads.

### DETAILED DESCRIPTION OF EXEMPLARY EMBODIMENTS OF THE INVENTION

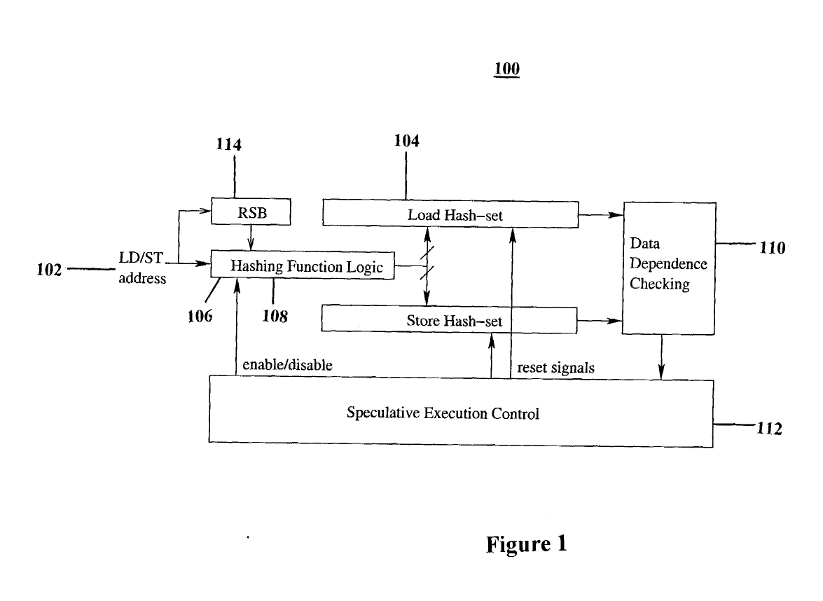

Referring now to the drawings, and more particularly to FIGS. 1-5, there are shown exemplary embodiments of the method and structures according to the present invention.

An exemplary embodiment of the invention uses a bit vector to record and encode the addresses of memory accesses. Each hardware thread keeps two bit vectors, referred to as hash-sets, one for load instructions 104 and one for store instructions 108. These hash-sets are part of the speculative thread management unit 100 (e.g., FIG. 1), a unit responsible with speculative thread spawning, commit, and rollback. The hash-sets are also attached to the load/store queue of a central processing unit. Adding addresses into the load and store hash-sets is controlled by the degree of speculation of different threads in the machine, by the committed load and store instructions executed, and by thread commit.

Assuming a model where there is one non-speculative thread and multiple speculative threads, when the non-speculative thread commits, its store hash-set is compared against all the load hash-sets of the speculative threads. If a conflict is detected, the speculative thread that had the conflict is rolled-back. Alternatively, all the threads more speculative then the speculative thread with the conflict are rolled-back.

In accordance with certain embodiments of the invention, the mechanism above may further include a small store queue for the most recent stores in order to minimize the false data dependencies in the case when the executing thread issues a store to a memory location before reading that memory location.

In accordance with certain embodiments of the invention, the hash function is allowed to dynamically adjust in order to take advantage of memory address patterns.

In accordance with certain embodiments of the invention, the bit vector hash-set may be replaced with a set of counters. This allows for a more precise control of which memory addresses are used to detect dependencies.

Applicants have discovered that detecting data dependence conflicts between multiple threads can be achieved by keeping less than exact information about memory accessing instructions. By keeping only summary information, false dependencies might be detected, but this will affect only performance and not correctness.

The present invention uses two separate bit vectors for each thread to store the summary information, one that stores the memory addresses accessed by the load instructions and one that stores the memory addresses accessed by the store instructions. These bit vectors are actually Bloom filters, which use a hashing function defined below. Multiple addresses are hashed together in the same bit vector. Dependencies between addresses encoding into two hash-sets are detected by doing simple boolean operations between the hash-sets.

In order to get better coverage, the bit vectors are partitioned into subsets. The partitioning has two advantages. First, the partitioning minimizes the number of conflicts in the hash-set (as opposed to generating 1 bit for each address, several bits are generated); and the partitions can be dynamically adjusted to better match the addressing pattern.

The processor maintains the load hash-set, the store hash-set, ordering information, and the processor checkpoint state (taken before the thread starts executing, needed in case the thread get squashed) for each running thread. All this information is stored in a structure called a Speculative Thread Management Unit (STMU), described in FIG. 1.

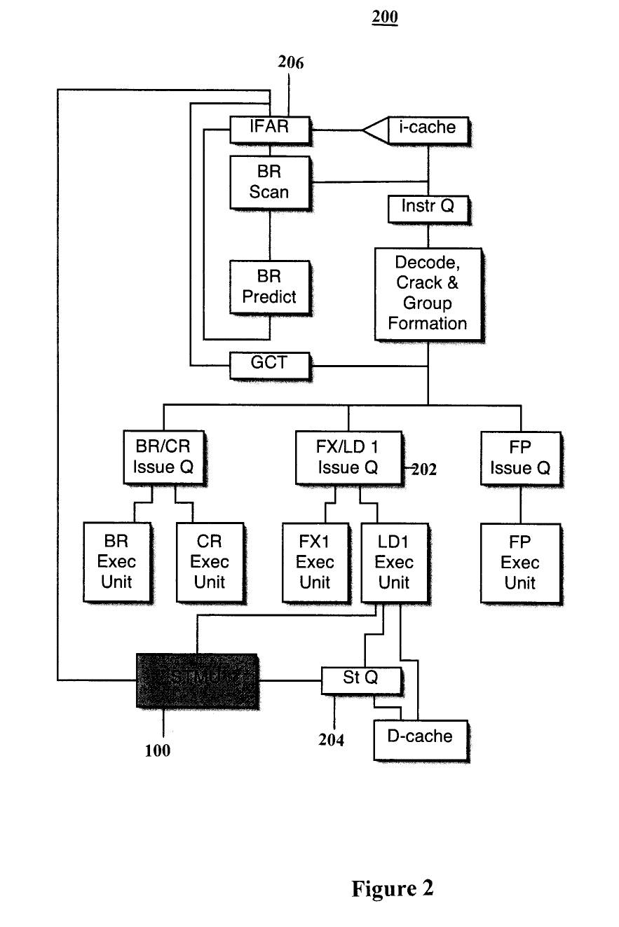

The STMU is responsible for updating the hash-set, comparing the hash-sets when a thread finishes and data dependence detection is needed. FIG. 2 shows a high-level block diagram of a processor including the STMU and what it is connected to.

In order to update the hash-sets, it is important to know the data addresses of all load and store instructions retired by the running threads. In most processors designs, the load and store queues are responsible for in-flight memory operations management and single-thread memory disambiguation. Therefore, a communication path is needed from the load 202 and store 204 queues and the STMU (e.g., see FIG. 2). The STMU makes decisions about what threads are spawned and squashed, and so it is also connected to the instruction fetch unit 206 (e.g., see FIG. 2).

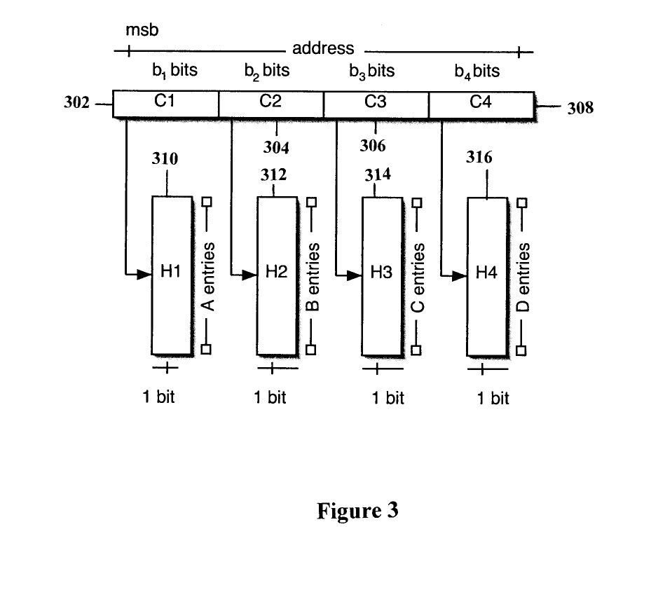

As opposed to most previous methods which produce one hash entry for each address, the address is partitioned into a number of chunks and the history bit vector in a number of subsets. Referring to FIG. 3, each of the subsets Cᵢ (302-308) corresponds to a number of bits bᵢ in the address and it is backed up by a bit-vector Hᵢ (310-316) of up to 2^{bi} bits. The concatenation of the Hᵢ bit-vectors forms the hash-set. The hash function simply uses the value in each subset of the address to set the bit in the corresponding bit-vector.

Adjusting the sizes of subsets and vectors makes it possible to make the hashing function more effective and reduce potential false-positives. Intuitively, H₁ (310) (the subset indexed by C1 (302), the high order bits) can be made small, since the high order bits of an address pattern change less often. On the other hand, making H₄ (316) large allows for addresses to consecutive memory locations to be hashed independently.

Optionally, a subset of the address bits can be ignored. For example, instead of individual addresses a user may be interested in cache lines. In this case, the input to the hashing logic will be an address with the lower bits masked. This will cause all the addresses that map to one cache line to hash to the same value in the filter, therefore the user can detect dependencies between cache line accesses.

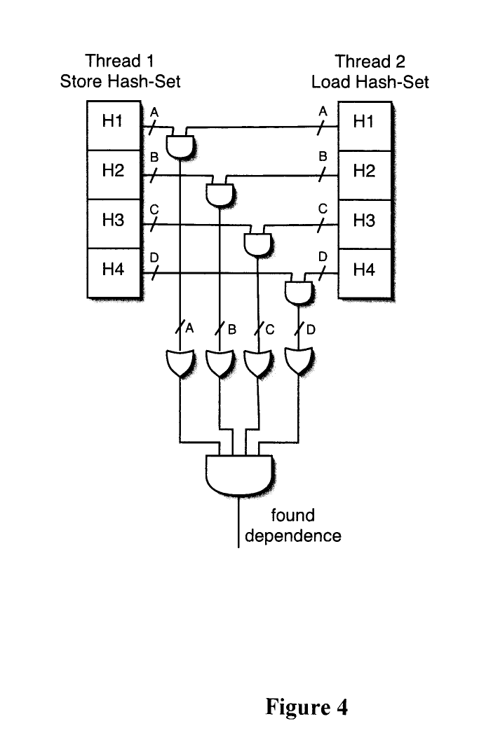

In the proposed scheme, dependence checking is performed when a thread completes. Its load hash-set is compared against the store hash-sets of other threads. In the case of speculative execution, the other threads are the threads that are either all the less speculative threads or the next speculative thread (if the finished thread is the non-speculative thread). In the case of parallel execution, the other threads are all the threads that run concurrently with the thread. The comparison is done by performing a bitwise logical AND between each pair of subsets from the hash-sets. If there is at least one bit set in every subset, the threads may have a data dependence. This is illustrated as a high-level logic diagram in FIG. 4.

One important characteristic of this invention is that data dependence detection is performed when a thread finishes (commit-time). In previous proposals, data dependence checking is performed on each memory operations of a given thread with respect to the other threads in the system. In those proposals, an exact set of dependence is kept.

The present invention creates a summary of the data produced and consumed by the threads in such a way that, when a thread commits, it is easy and quick to detect data dependence violations. The present invention does not check individual memory accesses. While the summary may encode an inexact sets of dependencies, the present invention guarantees that it is a super-set of the real set of dependencies, and therefore no real dependence will be missed.

In a speculative multithreaded environment, whenever there is only one thread (the non-speculative thread) running, there is no need to keep track of data dependencies. The STMU can keep track of this situation and disable the hashing logic, such that no memory accesses are recording in the load and store hash-sets. However, if there is at least one speculative thread, data dependencies need to be tracked. When a new thread is spawned, its load and store hash-set are reset.

In the case when there is at most one speculative thread in the system, data-dependence using hash-set occurs such that, the address of all load operations performed by the speculative thread are added to its load hash-set, the address of all store operations performed by the non-speculative thread are added to its store hash-set, only if a speculative thread exists in the system and when the current non-speculative thread completes its work, dependence violations are checked. If no violations are detected the speculative thread becomes non-speculative, and it can spawn another speculative thread. At his point, its load and store hash are reset. If a violation is detected, the speculative thread is squashed.

In a situation when multiple threads exist, threads commit their work in-order, even though they may have been spawned out-of-order. In this situation, the STMU keeps ordering information about the threads. The ordering information determines the order in which the hash-sets are compared.

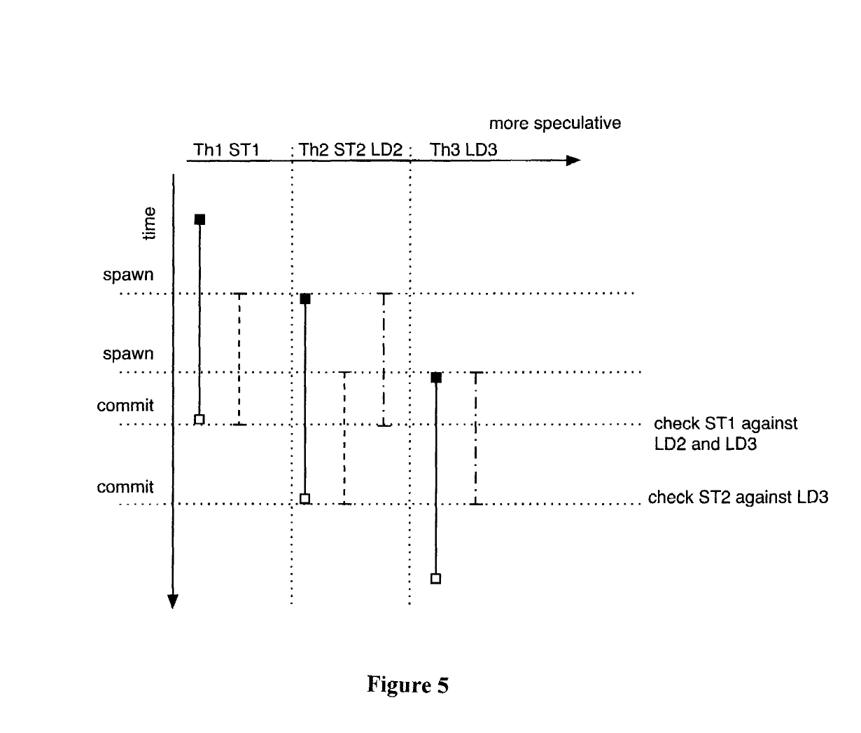

Whenever the non-speculative completes its work dependence violations are checked in order for the next thread in program order to become non-speculative. FIG. 5 shows an example of the dependence violation checking. When thread Th1 finishes, its store hash-set (ST1) is checked against the thread Th2's load hash-set (LD2) and thread Th3's load hash-set (LD3), and when thread Th2 finishes, it needs to check its store hash-set (ST2) against the more speculative thread Th3.

As mentioned before, the hash-based dependence detection guarantees that if there is a dependence it will be detected. However, an excessive number of false dependencies could be flagged even if the two threads access private or privatizable data. These data are memory locations that are written locally by the thread before they are read. To eliminate these false positives the present invention adds, for each thread, a queue that holds the addresses of a number of the most recent stores. This queue is referred to as the recent store buffer (RSB). The RSB has a First In First Out (FIFO) replacement policy. The RSB is checked for each load address. If the load address matches a store address in the RSB, the load is considered private load, and it is not added into the load hash-set.

This optimization uses address access patterns to minimize conflicts in the hash. For example, the high order bits of an address usually vary much less often than the lower bits of the address. Therefore, by using the present partitioning technique, a user can assign more entries to the lower bits of an address, and less entries to the higher bits and thus cover a larger address space while minimizing conflicts. This assignment of what bits of the address should be used is programmable.

The memory access pattern can vary significantly among applications. It can also vary significantly during the lifetime of an application execution. For that reason the present invention dynamically adjusts the hashing used in producing the hash-sets.

The hash function can be adjusted in many ways, for example, by changing the address partitions, or by performing XOR operations between the contents of a programmable register in the STMU and the sub-sets indexes.

In the context of multiple threads, it may happen that unnecessary dependencies are being accounted for. For instance, in FIG. 5, the stores performed by thread Th1 before thread Th3 was spawned should not be included in the dependence checking between thread Th1 and thread Th3. Using one bit vectors to encode the memory addresses does not allow keeping track of how many accesses at a particular address were executed.

However, if the hash-sets were encoded as a vector of counters, it would be possible to perform operations on the hash-sets that allow to compute if a memory operation was performed in a particular interval. For example, referring to FIG. 5, a snapshot S1 is taken of the store hash-set of thread Th1 at the moment when thread Th3 is spawned. When thread Th1 finishes, data dependence violations are checked between the load hash-set of thread Th3 and the difference between the store hash-set of thread Th1 and S1. This may further reduce the number of false dependencies.

While the invention has been described in terms of several exemplary embodiments, those skilled in the art will recognize that the invention can be practiced with modification within the spirit and scope of the appended claims.

Further, it is noted that, Applicants' intent is to encompass equivalents of all claim elements, even if amended later during prosecution.

What is claimed is:

1. A system for tracking memory dependencies integrated with a processor, comprising:
a speculative thread management unit, which uses a bit vector to record and encode addresses of memory access, said speculative thread management unit comprising:
a hashing unit that partitions the addresses into a load hash set and a store hash set;
a load hash set unit for storing said load hash set;
a store hash set unit for storing said store hash set; and
a data dependence checking unit that checks data dependence when a thread completes, by comparing a load hash set of the thread to a store hash set of other threads, wherein in a case of speculative execution, the other threads include threads that are either all of a plurality of less speculative threads or a next speculative thread, and wherein in a case of parallel execution the other threads include all thread that are currently running with the thread, said comparing comprises performing a bitwise logical AND between pairs of data subsets from said load hash set and said store hash set,
wherein said speculative thread management unit updates said load hash set and said store hash set.

2. The system according to claim 1, wherein said hashing unit dynamically adjusts its partitioning function to dynamically adjust to take advantage of memory access patterns

3. The system according to claim 2, wherein said load hash set and said store hash set are replaced with a set of counters.

4. The system according to claim 3, further comprising a recent store buffer that stores addresses of a number of most recent stores for each thread.

5. The system according to claim 4, wherein when a new thread is generated, said load hash set and said store hash set are reset.

6. The system according to claim 5, wherein when there is at most one speculative thread in the system, data dependence occurs such that an address of all load operations performed by the speculative thread are added to said load hash set, addresses of all store operations performed by non-speculative threads are added to said store hash set, and when the non-speculative thread is complete, dependence violations are checked, and
wherein when multiple speculative threads exist, the speculative thread management unit stores ordering information about the multiple speculative threads, the ordering information determining an order in which the hash sets are compared.
